(19) United States
(12) Patent Application Publication
(10) Pub. No.: US 2026/0140432 A1
(43) Pub. Date: May 21, 2026

(54) AWNING THEATER SYSTEM

(71) Applicants: Billy Shane Hulsey, Haleyville, AL (US); Valhalla Group LLC, Bear Creek, AL (US); American Manufacturers Supply, Inc., Haleyville, AL (US)

(72) Inventor: Ken Palmer, Bear Creek, AL (US)

(21) Appl. No.: 19/393,956

(22) Filed: Nov. 19, 2025

Related U.S. Application Data
(60) Provisional application No. 63/722,366, filed on Nov. 19, 2024.

(51) Int. Cl. G03B 21/58; E04H 15/08; G03B 21/14

(52) U.S. Cl. CPC G03B 21/58; E04H 15/08; G03B 21/145

(57) ABSTRACT

A recreational vehicle (RV) awning theater system includes an awning assembly. The awning assembly includes a first member configured to attach to a wall and comprising a housing for a projector screen and a second member positioned opposite the first member and configured to attach a projector facing the projector screen. The awning assembly can also include arms attached to each end of the second member to extend and retract the awning away from and towards the wall, with a speaker in an arm. A flexible canopy can be attached to the first and second members to provide a sheltered area. The awning assembly can be affixed to an RV to provide the awning theater system outside the RV.

### CROSS-REFERENCES TO RELATED APPLICATIONS

This application claims priority to U.S. Provisional Patent Application Ser. No. 63/722,366 filed Nov. 19, 2024, the entirety of which is incorporated by reference herein.

### TECHNICAL FIELD

The present disclosure generally relates to awning assemblies, and more particularly to an awning theater system with a projector and sound system.

### BACKGROUND

The present disclosure generally relates to awning assemblies, and more particularly to an awning theater system. Traditional awning assemblies provide cover with a canopy that extends from a wall, such as a building or the side of a recreational vehicle (RV) including but not limited to a camper, mobile home, motor home, or fifth wheel RV. While traditional awnings serve their purpose in creating shaded outdoor areas, there is growing demand among users for integrated entertainment solutions to increase the functionality of outdoor spaces. Additional accessories, such as an entertainment system, must be assembled separately each time the awning is extended from the wall. What is needed is an awning assembly that includes additional accessories within the assembly, or quickly connected to the assembly, that can be deployed together.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure generally relates to awning assemblies, and more particularly to an awning theater system with a projector and sound system for RVs. The awning theater system may be used in any environment where the system can be mounted to a wall having a substantially vertical face, such as a building or RV. The awning theater system can be provided for use as an outdoor entertainment system that is integrated with speakers, a projector, and a projector screen, for easy viewing and quick setup.

One aspect of the disclosure is an awning assembly defined by a first member configured to attach to a wall and having a housing with a first end, second end, and a top side, for a projector screen. The awning assembly may further include a second member having a first end and a second end, positioned opposite the first member and configured to attach a projector facing the projector screen. The awning assembly may further include a first arm attached to the first end of the second member and a second arm attached to the second end of the second member, with the first arm having a speaker. The awning assembly may further include a flexible canopy attached to the first member and the second member.

In some embodiments, the first arm and the second arm may be operable to retract against the wall. In some embodiments, the first arm may be supported by a first vertical support and the second arm may be supported by a second vertical support. The first and second vertical supports each may be attached to the wall. In some further embodiments, the first arm may be supported by a first intermediate support arm pivotally coupled to a first vertical support that may be attached to the wall, and the second arm may be supported by a second intermediate support arm pivotally coupled to a second vertical support that may be attached to the wall. In some further embodiments, the first intermediate support arm and the second intermediate support arm may be operable to lengthen or shorten, such that the second member is raised or lowered relative to the height of the first member.

In some embodiments, the first member may include a track and the housing for the projector screen may be slidable within the track. In some further embodiments, the first member may be further defined by a projector screen housing bracket on a bottom side of the first member and the top side of the housing for the projector screen housing to be slidable within the track. In some embodiments, the awning assembly may include a first projector screen housing flange attached to the first end of the housing for the projector screen and a second projector screen housing flange attached to the second end of the housing for the projector screen. A first mounting bracket may have a top flange attachable to the track in the first member, a bottom flange that may be configured to couple to the first projector screen housing flange by a quick release ball-lock pin, and a web section connecting the top flange and the bottom flange. A second mounting bracket may have a top flange attachable to the track in the first member, a bottom flange that may be configured to couple to the second projector screen housing flange by a quick release ball-lock pin, and a web section connecting the top flange and the bottom flange.

In some embodiments, the housing for the projector screen may be removable from the first member. In some embodiments, the projector screen may be retractable into the housing.

In some embodiments, the first member may include a speaker. In some further embodiments, the first member may be defined by a tubular shape having an internal compartment adjacent to a bottom side of the first member and an electrical raceway compartment adjacent to a front side of the first member. The first member may also include a track in a bottom side of the internal compartment, forming a longitudinal channel along a bottom surface of the first member, and may have an internal wall separating the channel from the remainder of the internal compartment. The first member may further include a penetration from the electrical raceway compartment through the front side of the first member, configured to allow an electrical cable to extend out of the first member to connect to the speaker or the housing for the projector screen. The first member may also include a slot extending longitudinally along the front side of the first member, the slot may be located above or below the penetration from the electrical raceway compartment, and the slot may have a curved profile. A speaker mounting bracket may have a first end that is configured to fit the curved profile of the slot in the front side of the first member, and a second end that may be coupled to a back side of the speaker. In some further embodiments, the speaker mounting bracket may be further defined by a pivoting transition section capable of adjusting the direction of the speaker.

In some embodiments, the awning assembly attaches to a wall that may be an exterior side of a recreational vehicle.

In some embodiments, the second member may be further defined by a first roller bracket attached to a side of the first arm, a second roller bracket attached to a side of the second arm, a roller extending between, and rotatably coupled to, the first roller bracket and the second roller bracket which may permit the flexible canopy to roll around the roller when the second member is moved towards the wall. The second member may include a second member electrical raceway that may have a tubular shape with a first end, a second end, a front face, and a back face, wherein the first end may be coupled to an end of the first arm, the second end may be coupled to an end of the second arm, and the second member electrical raceway may be located parallel to the roller with the front face closest to the roller. The second member may include a penetration through the tubular shape of the second member electrical raceway, configured to allow an electrical cable to extend out of the second member electrical raceway.

In some embodiments, the second member may include a track, and the projector may be slidable within the track. In some further embodiments, the second member may further include a projector mounting bracket on a bottom side of the second member that may be connected to a top side of the projector, wherein the projector mounting bracket may be slidable within the track. In some embodiments, the projector is removable from the second member.

In some embodiments, the awning assembly may include a lever system configured to retract the awning assembly away from the wall or towards the wall. In some further embodiments, the lever system may include a motor configured to move the awning assembly away from the wall or towards the wall. In some embodiments, the second member may include a speaker. In some embodiments, the speaker in the first arm may be removable. In some embodiments, the first arm may be further defined by a channel configured to route an electrical cable from a power supply to the second member and the speaker in the first arm.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a top front left overall perspective view of an example embodiment of an awning theater system in a deployed arrangement in accordance with the present disclosure.

FIG. 2 is a bottom front left overall perspective view of an example embodiment of an awning theater system in a deployed arrangement in accordance with the present disclosure.

FIG. 3 is a front elevation view of an example embodiment of an awning theater system in a deployed arrangement in accordance with the present disclosure.

FIG. 4 is a right side elevation view of an example embodiment of an awning theater system in a deployed arrangement in accordance with the present disclosure.

FIG. 5 is a left side elevation view of an example embodiment of an awning theater system in a deployed arrangement in accordance with the present disclosure.

FIG. 6 is an enlarged top front right perspective view of a portion of a first member having a detached first member speaker in an example embodiment of an awning theater system in a deployed arrangement in accordance with the present disclosure.

FIG. 6A is an enlarged top front right perspective view of a portion of a first member having a mounted first member speaker in an example embodiment of an awning theater system in a deployed arrangement in accordance with the present disclosure.

FIG. 7 is a cross-sectional side view of a first member having a mounted first member speaker and a mounted projector screen housing in an example embodiment of an awning theater system in a deployed arrangement in accordance with the present disclosure.

FIG. 8 is front right partial cross-sectional view of a projector screen housing mounting bracket connecting a projector screen housing to a first member in an example embodiment of an awning theater system in a deployed arrangement in accordance with the present disclosure.

FIG. 9 is an enlarged bottom front right perspective view of a first arm - second arm arrangement in an example embodiment of an awning theater system in a deployed arrangement in accordance with the present disclosure.

FIG. 10 is an enlarged top front right perspective view of a first arm - second arm arrangement in an example embodiment of an awning theater system in a deployed arrangement in accordance with the present disclosure.

FIG. 11 is a perspective view of a projector mounted to a second member in an example embodiment of an awning theater system in a deployed arrangement in accordance with the present disclosure.

FIG. 11A is a detail view of an example embodiment of a projector and a mounting bracket assembly in accordance with the present disclosure.

FIG. 12 is a cross-sectional side view of a second member having a mounted projector in an example embodiment of an awning theater system in a deployed arrangement in accordance with the present disclosure.

FIG. 13 is an enlarged front right perspective view of a partially exploded first intermediate support arm in an example embodiment of an awning theater system in a deployed arrangement in accordance with the present disclosure.

FIG. 14 is a bottom front left overall perspective view of an example embodiment of an awning theater system in a stowed arrangement in accordance with the present disclosure.

### DETAILED DESCRIPTION

Reference will now be made in detail to exemplary embodiments of the disclosure, some aspects of which are illustrated in the accompanying drawings. Each drawing is provided by way of explanation of the present disclosure and is not a limitation.

Those skilled in the art will recognize improvements and modifications to the preferred embodiments of the present disclosure. All such improvements and modifications are considered within the scope of the concepts disclosed herein and the claims that follow. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Unless specifically stated otherwise, any part of the awning theater system of the present disclosure may be made of any appropriate or suitable material including, but not limited to, metal, alloy, polymer, polymer mixture, composite, canvas, cloth, or any combination thereof.

The present disclosure is directed to an awning theater system, and more particularly to an awning theater system with a projector and sound system for a recreational vehicle (RV).

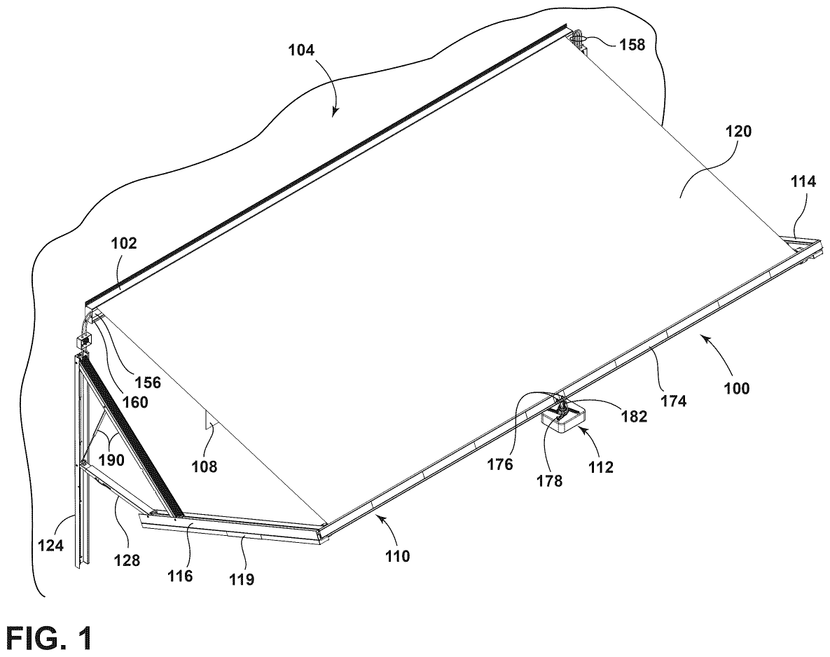

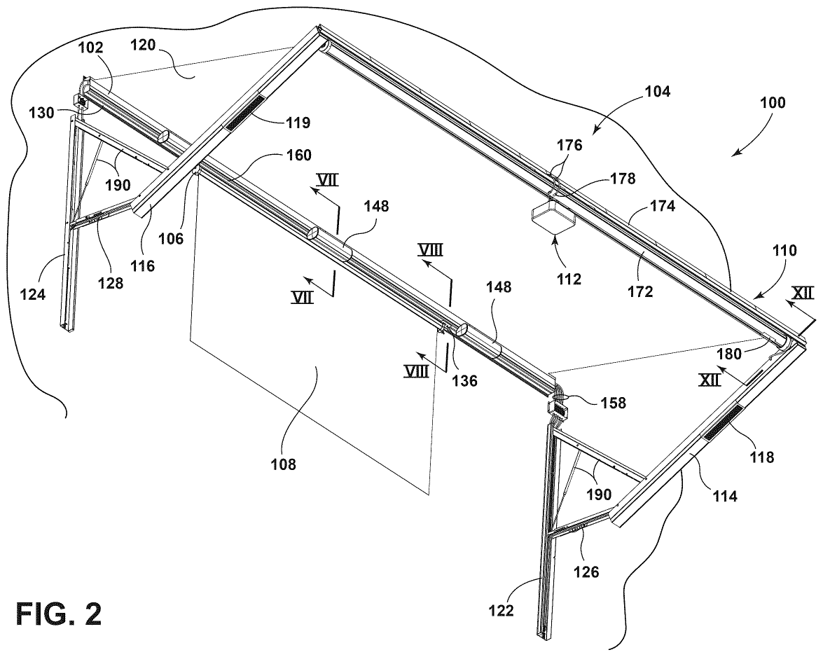

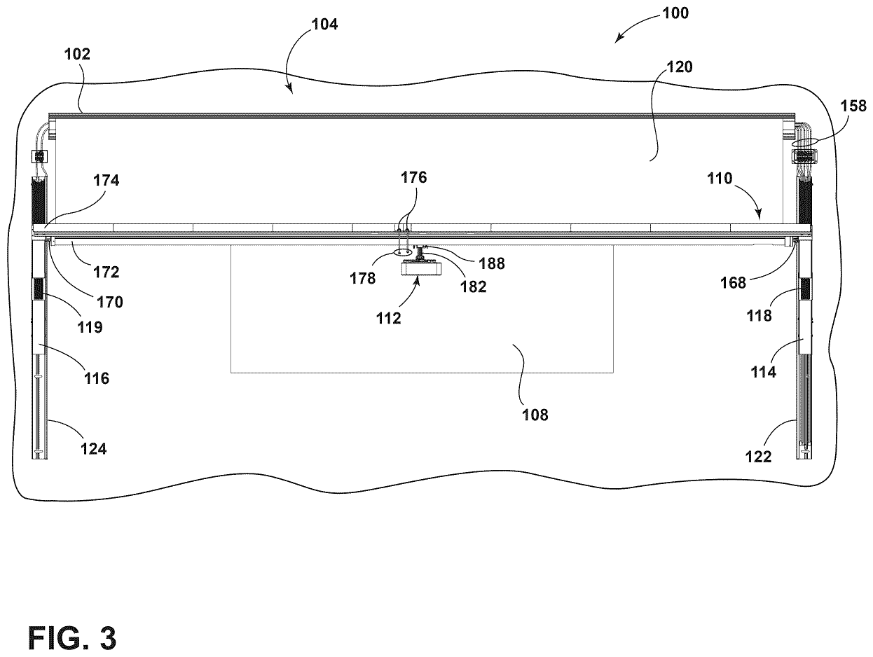

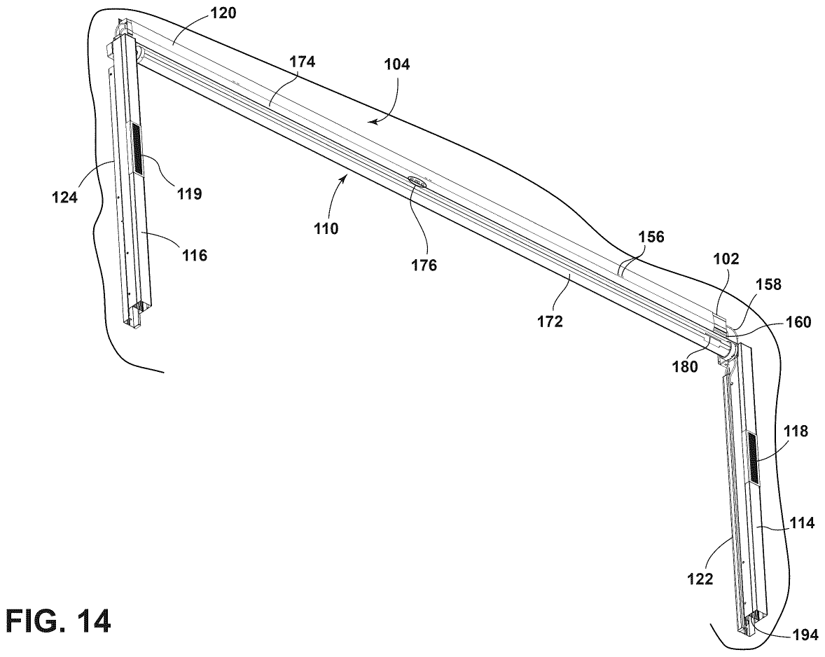

FIGS. 1 and 2 provide perspective views of an illustration of an example embodiment of an awning theater system 100 of the present disclosure. In the example of FIG. 1, the awning theater system 100 is an awning assembly that includes a first member 102 that can be attached to a wall 104, for instance at the upper portion of the wall 104. The wall 104 that the first member 102 can be affixed to may be a building, the exterior side of an RV, or any substantially vertical surface of sufficient strength to support the forces exerted by an awning assembly in a deployed or stowed arrangement. As shown in FIG. 2, the first member 102 may include a housing 106 for a projector screen 108. The housing 106 allows the projector screen 108 to be pulled down from the housing 106 and then retracted back into the housing 106 by a user or an automated mechanical mechanism so that the projector screen 108 is retracted into the housing 106 during non-use or RV transport. In some embodiments, the housing 106 can also be attached to the first member 102 with a bracket system that allows the housing 106 to be removed from the first member 102, such as during non-use or RV transport. The awning theater system 100 can also include a second member 110, having a first end and a second end, positioned opposite from the first member 102. As shown in FIGS. 1 and 2, a canopy 120 made of a flexible fabric material, such as canvas as one example, may be secured to and suspended between the first member 102 and the second member 110. In some embodiments, the second member 110 can include a roller 172 so that the canopy 120 can roll around the roller 172 when the awning theater system 100 is in a stowed position (e.g., when the second member 110 is moved towards the wall 104). FIG. 14 is an illustration of an example embodiment of an awning theater system 100 in a stowed position with the canopy 120 rolled around the roller 172. In a deployed position, as shown in FIGS. 1-5, the second member 110 can include a projector 112 facing the projector screen 108. The projector 112 can be mounted to the second member 110 with a bracket system that allows the projector 112 to be removed from the second member 110 during RV transport. Any power or audio-visual supplies from a power source to the projector 112, when the projector 112 is affixed to the second member 110, may be routed around or inside the first member 102, the second member 110, a first arm 114, or a second arm 116.

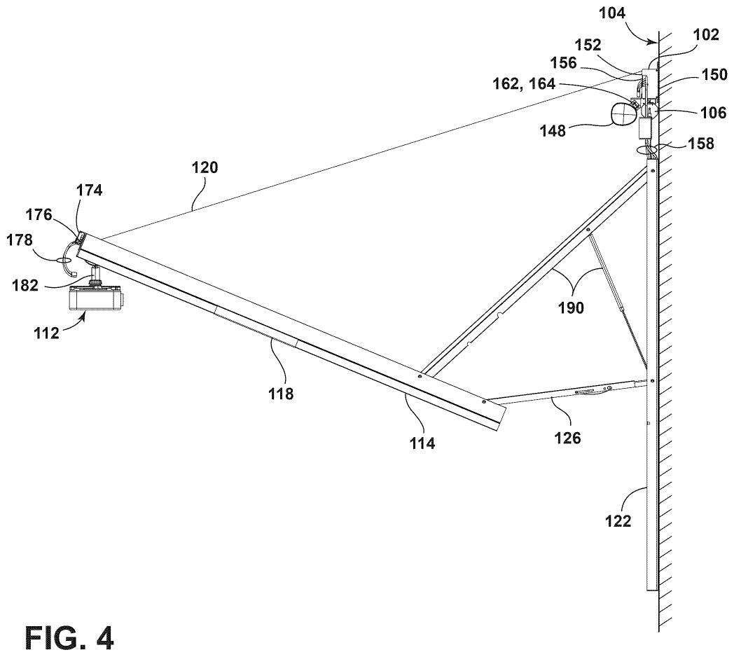

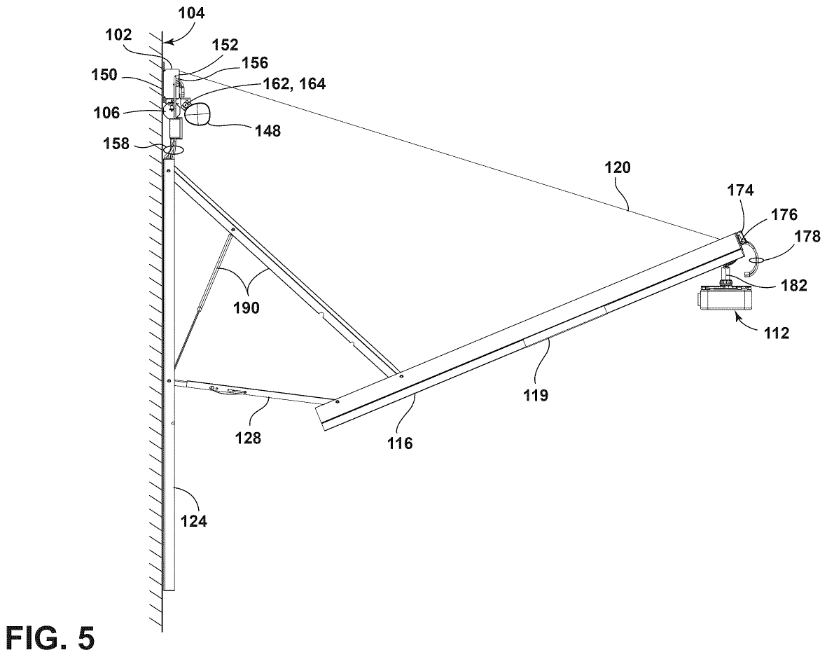

FIGS. 4 and 5 illustrate side elevation views of an example embodiment of an awning theater system 100 of the present disclosure. A first arm 114 can be attached to the first end of the second member 110 and a second arm 116 can be attached to the second end of the second member 110 to support the second member 110 above the ground. Although a first arm 114 and second arm 116 are designated on the Figures, references to a first arm could refer to either arm supporting the second member 110 and is not intended to limit such designation to a specific position in a specific embodiment. As shown in the example embodiment in FIG. 2, the first arm 114 may include a speaker 118 embedded within the first arm 114. In some embodiments, a speaker may be embedded in the first arm 114 and in the second arm 116. In some embodiments, the speaker 118 may be pre-installed in the first arm 114 and the speakers may be of a weatherproof construction or have a weatherproof cover. In some embodiments, a speaker 118 can be attached to the first arm 114 for use and removed from the first arm 114 during RV transport. Any power or audio-visual supplies from a power source or from the projector 112 to the speaker 118 may be routed around or inside the first member 102, the second member 110, the first arm 114, or the second arm 116.

As illustrated in FIG. 4, the first arm 114 may be attached to a first vertical support 122 that is attached to the wall 104 via one or more first intermediate support arms 126, and as illustrated in FIG. 5, the second arm 116 may be attached to a second vertical support 124 that is attached to the wall 104 via one or more second intermediate support arms 128. In some embodiments, the first arm 114 may be attached to the first vertical support 122 that is attached to the wall 104, and the second arm 116 may be attached to the second vertical support 124 that is attached to the wall 104. The first arm 114 and second arm 116 are operable to be retracted against the wall 104, for instance during RV transport. FIG. 14 is an illustration of an example embodiment of an awning theater system 100 in a retracted arrangement, such as during RV transport. The first arm 114 and second arm 116 may be retracted against the wall 104 via hinges in the first arm 114 and second arm 116, and/or the first intermediate support arm 126 and the second intermediate support arm 128. In some embodiments, the first intermediate support arm 126 and second intermediate support arm 128 may be further defined to include a closing member 190 (e.g., hydraulic lift support) connected to the first vertical support 122 and second vertical support 124 such that a user or an automated mechanical mechanism (e.g., a lever system or motorized lever system) can push the first arm 114, second arm 116, first intermediate support arm 126 and second intermediate support arm 128 against the wall 104. For example, the awning theater system 100 can be operable by a manual system, in which the first arm 114 and second arm 116 are spring-loaded such that a user can walk out the awning and set the tension manually, or a hybrid system with an awning rod that a user rotates to open and close the awning canopy.

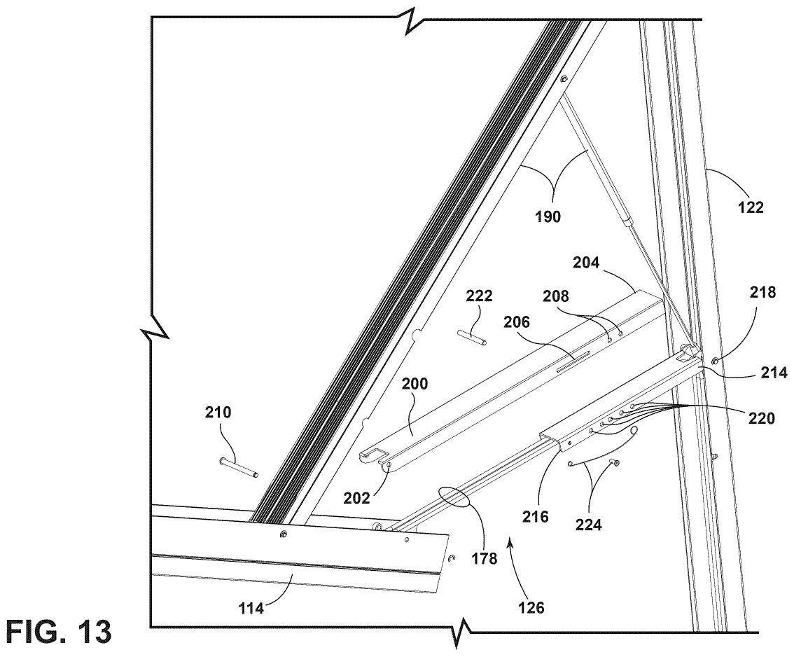

In some embodiments, the first intermediate support arm 126 and second intermediate support arm 128 may be lengthened or shortened to raise or lower the height of the second member 110 relative to the height of the first member 102. As shown in the exploded view in FIG. 13, in some embodiments the first intermediate support arm 126 may be further defined by an outer sleeve member 200, having a tubular or open shape with a first end 202 and a second end 204, and an inner sleeve member 212, having a tubular or open shape with a first end 214 and a second end 216, where the outer sleeve member 200 and inner sleeve member 212 are sized to slidably nest together. The outer sleeve member first end 202 may be pivotally coupled to the first arm 114 by a pin 210 or other appropriate fastener connecting through holes in the first arm 114 and outer sleeve member first end 202. The inner sleeve member first end 214 may be pivotally coupled to the first vertical support 122 by a pin 218 or other appropriate fastener connecting through holes in the first vertical support 122 and inner sleeve member first end 214. In some embodiments, the inner sleeve member second end 216 may slide into the outer sleeve member second end 204. In some embodiments, the inner sleeve member 212 may have a retention hole in a side near the second end 216 and the outer sleeve member 200 may have a slotted opening 206 in a side to allow a retention pin 222 or other appropriate fastener to couple the inner sleeve member 212 and outer sleeve member 200 while defining a minimum and maximum adjustment range based on the length of the slotted opening 206 in the outer sleeve member 200. The outer sleeve member 200 may also have a plurality of holes 208 in a side, located between the slotted opening 206 and the outer sleeve member second end 204. The inner sleeve member 212 may also have a plurality of holes 220 in a side, located between the retention hole and the inner sleeve member first end 214.

The first intermediate support arm 126 may be adjusted to a desired length, for example, by sliding the outer sleeve member 200 and the inner sleeve member 212 relative to each other until the adjustment holes 208, 220 are aligned. An adjustment pin 224 may be inserted to secure the outer sleeve member 200 to the inner sleeve member 212 at the desired first intermediate support arm 126 length. The adjustment pin 224 may be a bolt, quick release pin, cotter pin, or other appropriate fastener. In some embodiments, electrical cables 178 may be routed through the open space in the tubular or open shape of the inner sleeve member 212 and outer sleeve member 200 to provide power or audio-visual supplies from a power source to components in the first arm 114 or second member 110. In some embodiments, the adjustment pin 224 may include a cable, wire, collar, or other flexible material connected to the retention pin 222 to retain the adjustment pin 224 when not inserted in the holes 208, 220, such as during adjustment of the first intermediate support arm 126. The adjustment to the length of the first intermediate support arm 126 may be accomplished, for example, by two support members slidably nested together with a series of holes in adjacent side walls that can be secured at a desired length by a fastener such as a bolt, a quick release pin, cotter pin, or other appropriate fastener. A similar mechanism may also be used for an adjustable second intermediate support arm 128 connected to the second vertical support 124 and second arm 116.

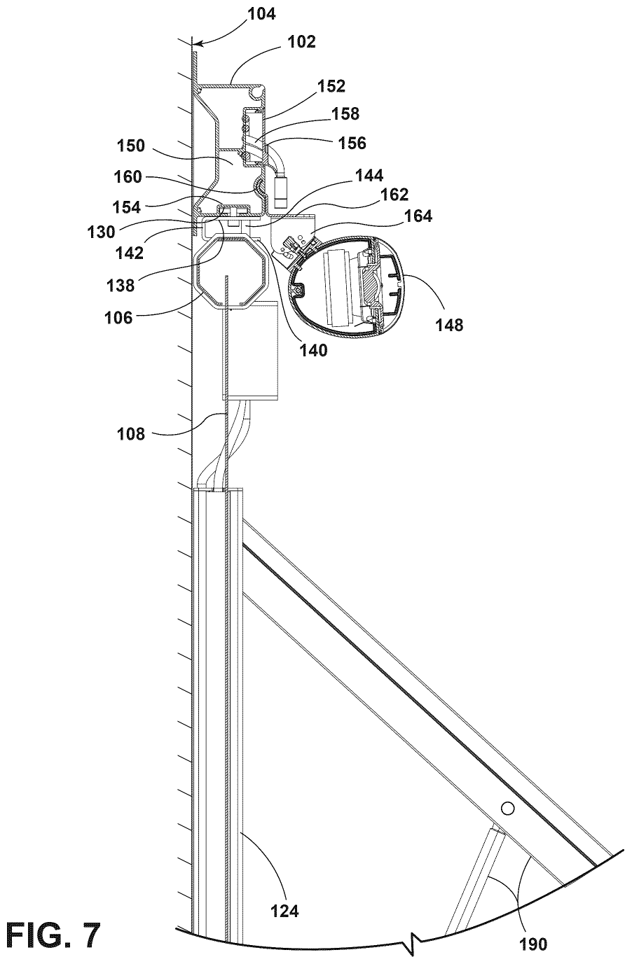

FIG. 2 is an illustration of an example embodiment of the awning theater system 100 where the first member 102 includes a first member track 130 to allow the housing 106 for the projector screen 108 to be moved horizontally to allow for optimal viewing of the projector screen 108 and to move housing 106 and the projector screen 108 away from hazards such as an RV door. In some embodiments, a mounting bracket may fit in the first member track 130 and attach to the top of the housing 106 to allow the housing 106, and thus the projector screen 108, to move horizontally along the first member 102. In some embodiments, illustrated in FIG. 8 as an example, the housing 106 for the projector screen 108 includes a housing flange 134 protruding from opposite ends of the housing 106. A housing mounting bracket 136 may fit in or connect to the first member track 130. The housing mounting bracket 136 in the example embodiment is a U-shaped bracket having a housing mounting bracket top flange 138, a housing mounting bracket bottom flange 140, and a housing mounting bracket web section 142 that connects the flanges; however, other bracket shapes may be suitable to connect the housing 106 to the first member 102. The housing mounting bracket top flange 138 in the example embodiment attaches to a block that slidably fits in the first member track 130 by two fixing bolts, but other fasteners may be used to secure the housing mounting bracket top flange 138 to the first member track 130. The housing mounting bracket bottom flange 140 is configured to support the housing flange 134 and align a through-hole in the mounting bracket bottom flange 140 and the housing flange 134 to permit a quick release ball-lock pin 144 or other fastener to secure the housing 106 to the housing mounting bracket 136. One having skill in the art will recognize the advantage of such embodiment to permit the quick removal of the housing 106 and projector screen 108 from the first member 102 when stowing the awning theater system while retaining the horizontal position memory of the housing 106 relative to the first member 102 due to the housing mounting bracket 136 remaining in or attached to the first member track 130. In some embodiments, the housing 106 can be moved along the first member track 130 manually or with an automated mechanical mechanism.

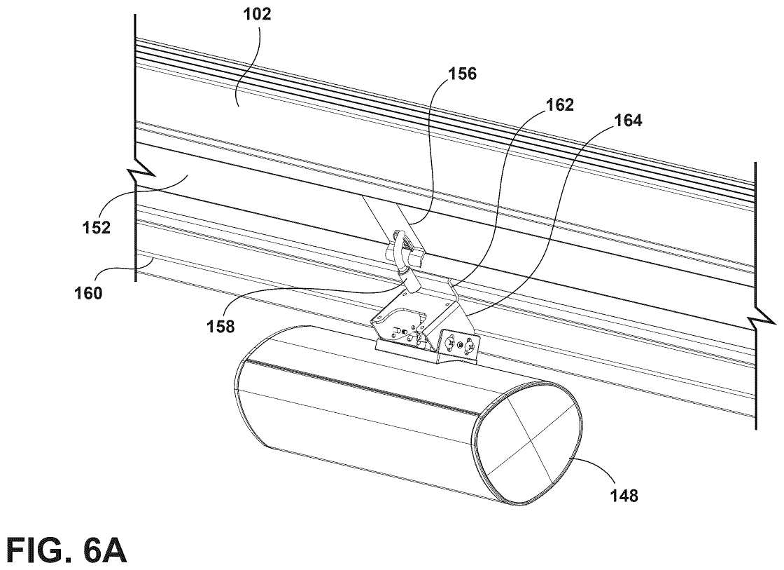

FIG. 7 is a cross-sectional side view of an example embodiment of the awning theater system 100 where the first member 102 includes a first member speaker 148. In some embodiments, the first member 102 may have a tubular shape construction defined by a first member internal compartment 150 adjacent to a bottom side of the first member 102 and an electrical raceway compartment 152 adjacent to a front side of the first member 102. The bottom side of the first member internal compartment 150 may include a longitudinal channel along a bottom surface of the first member 102, forming the first member track 130. In some embodiments, the first member track 130 may be separated from the remainder of the first member internal compartment by an internal wall 154, with the shape of the internal wall 154 defining the profile of the first member track 130 (e.g., a T-shape, ball race). The electrical raceway compartment 152 may be any shape sufficient to accommodate one or more electrical cables 158 providing power or audio-visual supplies to components of the awning theater system 100. In some embodiments, the electrical raceway compartment 152 may include a penetration 156 from the electrical raceway compartment 152 through the front side of the first member 102, the penetration 156 configured to permit an electrical cable 158 to extend out of the first member 102 to connect to the first member speaker 148. The penetration 156 may include a cap or plug to seal the electrical raceway compartment 152 from the weather when a first member speaker 148 is not in use. In some embodiments, the front face of the first member 102 may be further defined by a slot 160 extending longitudinally along the front side of the first member 102, where the slot 160 is located above or below the penetration 156 from the electrical raceway compartment 152. In the example embodiment of FIG. 7, the slot 160 has a curved profile, but other shapes or angled profiles may be used to achieve the benefit of a quick connection and retention of accessories on the front side of the first member 102.

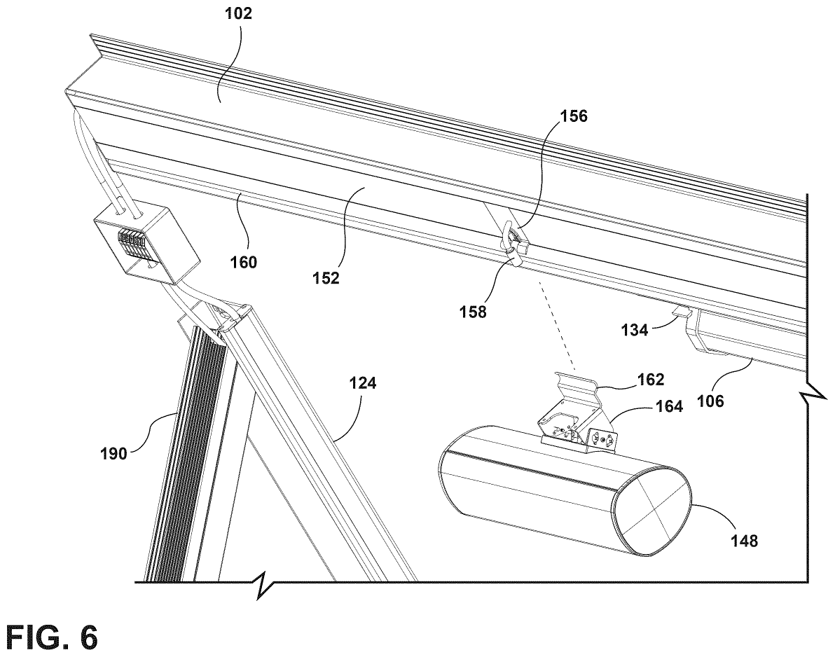

In some embodiments, a speaker mounting bracket 162 may be used to connect the first member speaker 148 to the first member 102. The speaker mounting bracket 162 may have a first end that is configured to fit the profile of the slot 160 in the first member 102, and a second end attachable to a back side of the first member speaker 148 by a screw, pin, or other fastener. In some embodiments, the speaker mounting bracket 162 may further include a speaker mounting bracket pivot transition section 164 that connects the first end and second end of the speaker mounting bracket 162 to allow a user to adjust the direction of the first member speaker 148. FIGS. 6 and 6A are illustrations of the first member speaker 148 detached from the first member 102 and attached to the first member 102 by the speaker mounting bracket 162 having a pivot transition section 164. The first member speaker 148 can include any form of wired or wireless speaker system to allow media to play through the first member speaker 148. Any power or audio supplies for the first member speaker 148 may be routed from a power source to the first member speaker 148 around or inside the first member 102, second member 110, first arm 114, or second arm 116.

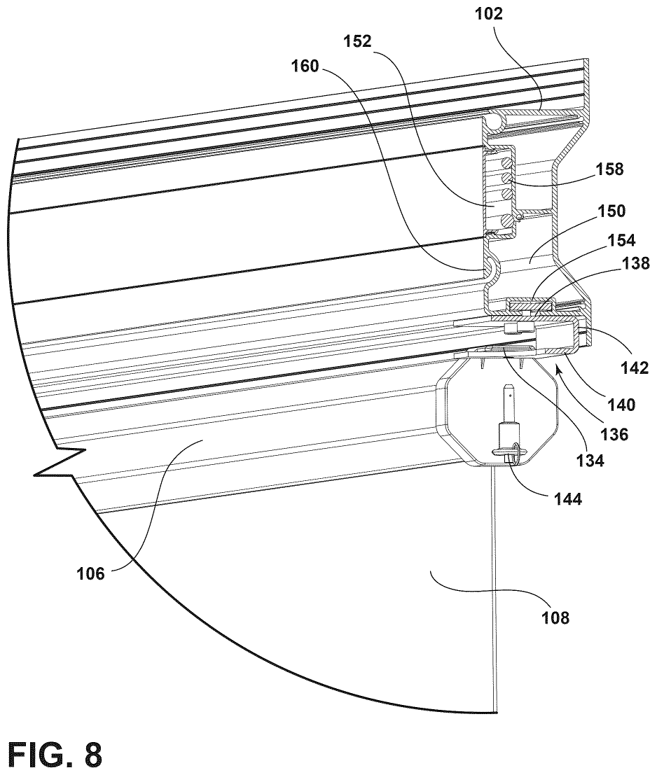

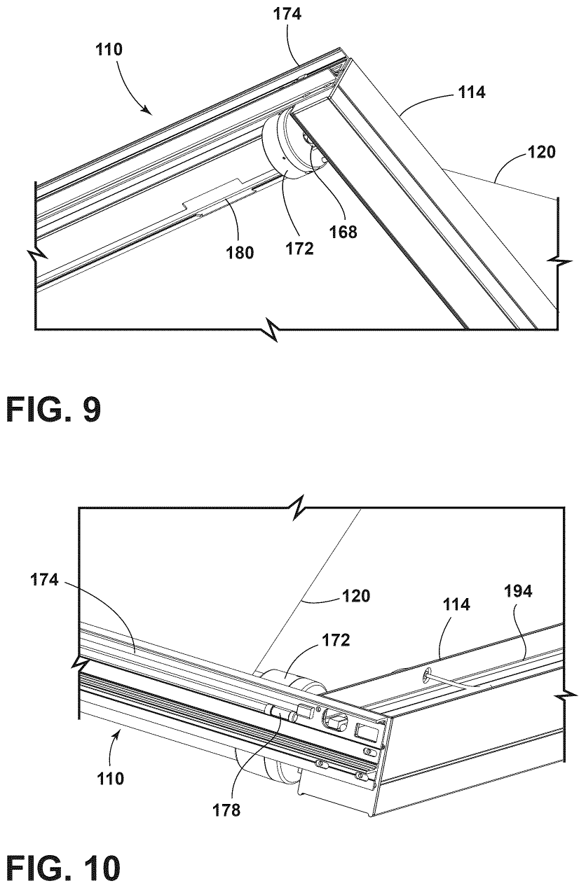

FIGS. 2 and 9 are illustrations of an example embodiment of the awning theater system 100 where the second member may be further defined by a first roller bracket 168 attached to a side of the first arm 114, a second roller bracket 170 attached to a side of the second arm 116, and a roller 172 that extends between, and is rotatably coupled to, the first roller bracket 168 and second roller bracket 170. In some embodiments, the roller 172 may be a solid shaft seated in bushings in the first roller bracket 168 and second roller bracket 170. In some embodiments, the roller 172 may be a tubular shape, such as an extruded aluminum cylinder, with stub shafts to rotatably couple to the first roller bracket 168 and second roller bracket 170. The canopy 120 may connect to the roller 172 using external divots, channels, or other attachment, or by connecting to an anchor connection inside the roller 172. In some embodiments, the roller 172 may rotate as the second member 110 is retracted towards the wall 104, to roll the canopy 120 around the roller 172 when stowing the awning theater system 100. In some embodiments, an automated mechanical mechanism (e.g., a motor or spring tensioner system) may rotate the roller 172. In some embodiments, such as the example embodiment in FIGS. 9 and 10, the second member 110 may be further defined by a second member electrical raceway 174 having a tubular shape of sufficient size to accommodate one or more electrical cables 178 providing power or audio-visual supplies to components of the awning theater system 100. The second member electrical raceway 174 may have a first end, a second end, a front face, and a back face. In some embodiments, the second member electrical raceway 174 may be located parallel to the roller 172 with the first end attachable to an end of the first arm, the second end attachable to an end of the second arm, and the front face closest to the roller 172. In some embodiments, the second member electrical raceway 174 may include a penetration 176 through the back face of the second member electrical raceway 174, the penetration 176 configured to permit an electrical cable 178 to extend out of the second member 110 to connect to components of the awning theater system 100. The penetration 176 may include a cap or plug to seal the second member electrical raceway 174 from the weather when the awning theater system 100 is not in use.

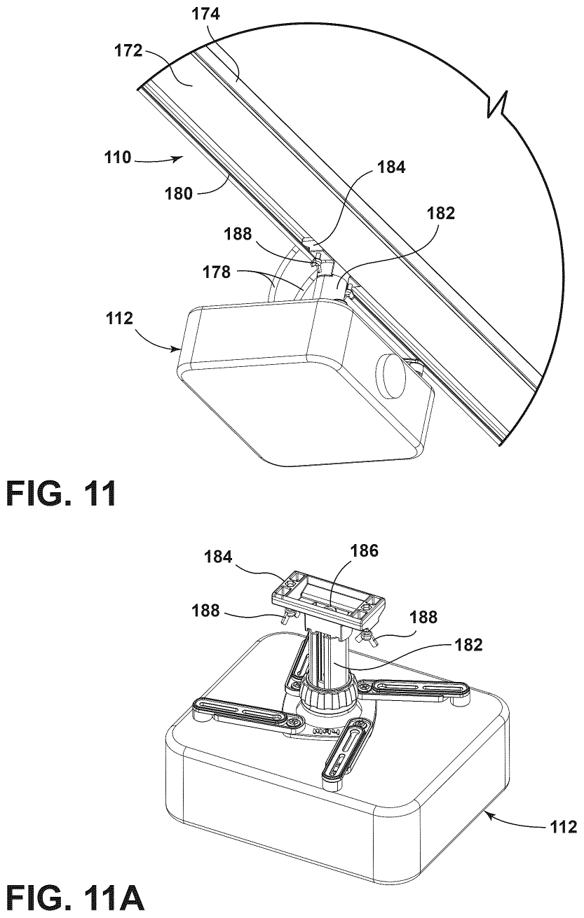

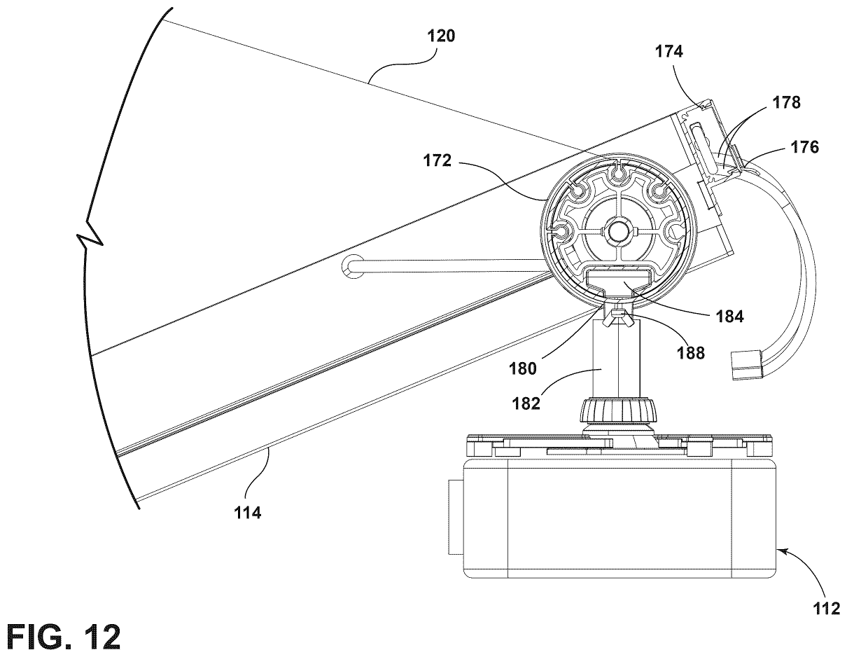

FIG. 11 is an illustration of an example embodiment of the awning theater system 100 where the second member 110 includes a second member track 180 to allow the projector 112 to be moved horizontally to maintain alignment with the projector screen 108 when the housing 106 is moved to avoid hazards, such as an RV door. In some embodiments, a mounting bracket may fit in the second member track 180 and attach to the top of the projector 112 to allow the projector to move horizontally along the second member 110. In some embodiments, illustrated in FIG. 11A as an example, a projector mounting bracket 182 may connect to a sliding block 184 that fits in the second member track 180 by a fixing bolt 186, where the sliding block 184 is slidable within the second member track 180 and may be fixed to a desired position by tightening a wing bolt 188. The fixing bolt 186 may be any type of fastener, including quick connect pins, to connect the sliding block 184 to the projector mounting bracket 182. One having skill in the art will recognize the advantage of such an embodiment to permit the quick removal of the projector 112 and projector mounting bracket 182 to allow the canopy 120 to roll around the roller 172 for storage while retaining the horizontal position memory of the projector 112 relative to the second member 110 due to the sliding block 184 remaining in the second member track 180. In some embodiments, the projector mounting bracket 182 or sliding block 184 may be moved along the second member track 180 manually or with an automated mechanical mechanism. FIG. 12 is a cross-sectional view of an example embodiment where the second member 110 includes a roller 172, a second member electrical raceway 174, and a projector 112 mounted to the second member 110 by a sliding block 184 and projector mounting bracket 182.

In some embodiments, where the projector 112 to the roller 172 and the canopy 120 rolls around the roller 172 when stowing the awning theater system 100, the projector 112 must be removed before stowing the awning theater system 100. In some embodiments, the second member 110 may be further defined by a speaker that is attachable to the second member track 180 by a speaker mounting bracket similar to the speaker mounting bracket 162 used with the first member 102. Any power or audio-visual supplies from a power source or from the projector 112 to the speaker may be routed around or inside the first member 102, the second member 110, the first arm 114, or second arm 116.

In some embodiments, the power or audio-visual electrical cables may be routed through the first arm 114 or the second arm 116. The first arm 114 or the second arm 116 may be further defined by grooves or channels 194 running the length of the first arm 114 or the second arm 116, configured to seat electrical cables into the channels 194. The channels 194 may prevent electrical cables from tangling, kinking, or breaking when the first arm 114 or the second arm 116 is retracted towards the wall 104. The channels 194 may be located in the arm such that the electrical cables pass above or below the speaker 118.

The presently disclosed systems have a wide application anywhere in the outdoor theater systems industry in general. One particularly important application for the systems described herein relates to outdoor theater systems for RVs. However, the systems described above could be utilized in other contexts.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. An awning assembly, comprising:
a first member configured to attach to a wall and comprising a housing, having a first end, a second end, and a top side, for a projector screen;
a second member, having a first end and a second end, positioned opposite the first member and configured to attach a projector facing the projector screen;
a first arm attached to the first end of the second member and a second arm attached to the second end of the second member, and the first arm comprising a speaker; and
a canopy attached to the first member and the second member.

2. The awning assembly of claim 1, wherein the first arm and the second arm are operable to retract against the wall.

3. The awning assembly of claim 2, wherein the first arm is supported by a first vertical support and the second arm is supported by a second vertical support, and the first and second vertical supports are each attached to the wall.

4. The awning assembly of claim 2, wherein the first arm is supported by a first intermediate support arm pivotally coupled to a first vertical support that is attached to the wall, and the second arm is supported by a second intermediate support arm pivotally coupled to a second vertical support that is attached to the wall.

5. The awning assembly of claim 4, wherein the first intermediate support arm and the second intermediate support arm are operable to lengthen or shorten, such that the second member is raised or lowered relative to the height of the first member.

6. The awning assembly of claim 1, wherein the first member comprises a track and the housing for the projector screen is slidable within the track.

7. The awning assembly of claim 6, further comprising a projector screen housing bracket on a bottom side of the first member and the top side of the housing for the projector screen, wherein the projector screen housing bracket is slidable within the track.

8. The awning assembly of claim 6, further comprising:
a first projector screen housing flange attached to the first end of the housing for the projector screen and a second projector screen housing flange attached to the second end of the housing for the projector screen;
a first mounting bracket having a top flange fastened to the track in the first member, a bottom flange configured to be coupled to the first projector screen housing flange by a quick release ball-lock pin, and a web section connecting the top flange and the bottom flange; and
a second mounting bracket having a top flange fastened to the track in the first member, a bottom flange configured to be coupled to the second projector screen housing flange by a quick release ball-lock pin, and a web section connecting the top flange and the bottom flange.

9. The awning assembly of claim 1, wherein the housing for the projector screen is removable from the first member.

10. The awning assembly of claim 1, wherein the projector screen is retractable into the housing.

11. The awning assembly of claim 1, wherein the first member further comprises a speaker.

12. The awning assembly of claim 11, wherein the first member comprises a tubular shape having an internal compartment that is adjacent to a bottom side of the first member and an electrical raceway compartment that is adjacent to a front side of the first member, and further includes:
a track in a bottom side of the internal compartment, forming a longitudinal channel along a bottom surface of the first member, and having an internal wall disposed around the channel within the internal compartment;
a penetration from the electrical raceway compartment through the front side of the first member, configured to allow an electrical cable to extend out of the first member to connect to the speaker or the housing for the projector screen;
a slot extending longitudinally along the front side of the first member, the slot located above or below the penetration from the electrical raceway compartment, and having a curved profile; and
a speaker mounting bracket having a first end that is configured to fit the curved profile of the slot and a second end coupled to a back side of the speaker.

13. The awning assembly of claim 1, wherein the wall comprises an exterior side of a recreational vehicle.

14. The awning assembly of claim 1, wherein the second member comprises:
a first roller bracket attached to a side of the first arm;
a second roller bracket attached to a side of the second arm;
a roller extending between, and rotatably coupled to, the first roller bracket and the second roller bracket wherein the canopy rolls around the roller when the second member is moved towards the wall;
a second member electrical raceway, having a tubular shape with a first end, a second end, a front face and a back face, wherein the first end is coupled to an end of the first arm, the second end is coupled to an end of the second arm, and the second member electrical raceway is located parallel to the roller with the front face closest to the roller; and
a penetration through the tubular shape of the second member electrical raceway, configured to allow an electrical cable to extend out of the second member electrical raceway.

15. The awning assembly of claim 1, wherein the second member comprises a track and the projector is slidable within the track.

16. The awning assembly of claim 15, further comprising a projector mounting bracket on a bottom side of the second member and a top side of the projector, wherein the projector mounting bracket is slidable within the track.

17. The awning assembly of claim 1, wherein the projector is removable from the second member.

18. The awning assembly of claim 1, further comprising a lever system configured to retract the awning assembly away from the wall or towards the wall.

19. The awning assembly of claim 1, wherein the second member includes a speaker.

20. The awning assembly of claim 1, wherein the speaker in the first arm is removable.
